(19) United States
(12) Patent Application Publication
(10) Pub. No.: US 2007/0084394 A1
(43) Pub. Date: Apr. 19, 2007

(54) Power generation in watercraft

(76) Inventor: Peter Gudmundson, Plymouth, MN (US)

Correspondence Address: LEFFERT JAY & POLGLAZE, P.A., P.O. BOX 581009, MINNEAPOLIS, MN, 55458-1009, US

(21) Appl. No.: 11/253,499

(22) Filed: Oct. 19, 2005

(51) Int. Cl. B60L 11/02; B63H 21/17; B60L 11/16

(52) U.S. Cl. 114/121; 440/6

(57) ABSTRACT

An electrical power generation system for watercraft including movable ballast, an electrical generator, and a shaft connected between the ballast and the electrical generator.

### TECHNICAL FIELD OF THE INVENTION

The present invention relates generally to power generation and in particular the present invention relates to power generation in watercraft.

### BACKGROUND OF THE INVENTION

Watercraft, such as sailboats, often have one or more electrical devices, such as navigation equipment, autopilots, DVD players, lights, etc. Therefore, many sailboats are equipped with electrical power generation systems and electrical power storage devices. Some electrical power generation systems include solar panels containing arrays of solar cells (or photovoltaic cells) for converting solar energy into electricity, but such devices do not produce much power and are often not aesthetically pleasing. Electrical power generation systems that include generators driven by diesel or gasoline motors are often used, but these systems pollute the environment, are typically noisy, etc.

For the reasons stated above, and for other reasons stated below which will become apparent to those skilled in the art upon reading and understanding the present specification, there is a need in the art for alternative electrical power generation systems for use in watercraft.

### SUMMARY

The above-mentioned problems with electrical power generation systems for watercraft and other problems are addressed by the present invention and will be understood by reading and studying the following specification.

For one embodiment, the invention provides an electrical power generation system for watercraft including movable ballast, an electrical generator, and a shaft connected between the ballast and the electrical generator.

Further embodiments of the invention include methods and apparatus of varying scope.

### BRIEF DESCRIPTION OF THE DRAWINGS

FIG. 1 illustrates a watercraft, according to an embodiment of the invention.

FIG. 2 illustrates an electrical power generation system for a watercraft, according to another embodiment of the invention.

FIG. 3 illustrates a portion of an electrical power generation system for watercraft, according to another embodiment of the invention.

FIG. 4 illustrates movable ballast for use in an electrical power generation system for watercraft, according to another embodiment of the invention.

### DETAILED DESCRIPTION

In the following detailed description of the invention, reference is made to the accompanying drawings that form a part hereof, and in which are shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention. The following detailed description is, therefore, not to be taken in a limiting sense, and the scope of the present invention is defined only by the appended claims and equivalents thereof.

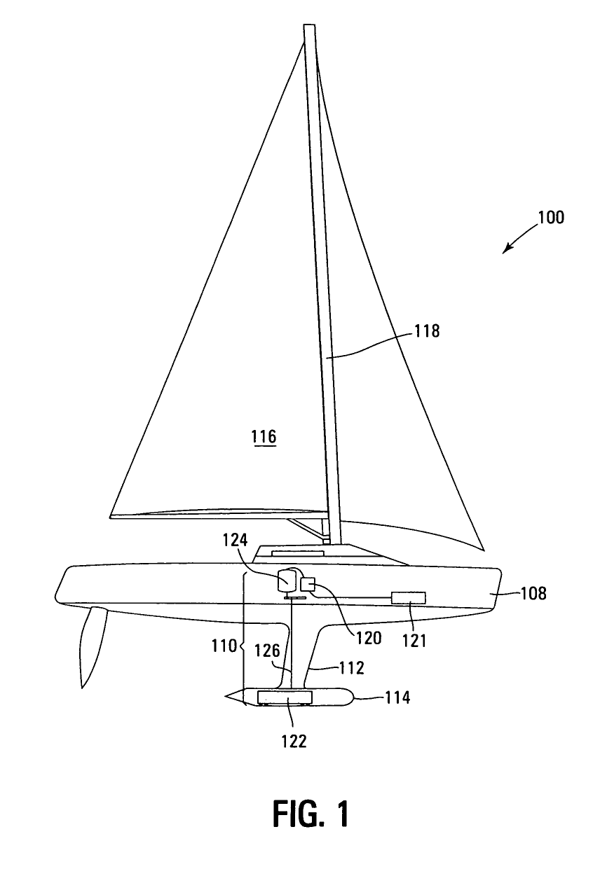

FIG. 1 illustrates a watercraft 100, such as a sailboat, according to one embodiment. Watercraft 100 includes a hull 108. A keel 112 protrudes from an exterior of hull 108. For one embodiment, a keel bulb 114 is connected to keel 112. For another embodiment, sails 116 are disposed on a mast 118 that is secured to an interior of hull 108. Watercraft 100 includes an electrical power generation system 110 electrically connected to a storage device 120, such as a battery. For one embodiment, electrical power generation system 110 includes movable ballast 122, an electrical generator 124, and a drive shaft 126 connected between ballast 122 and electrical generator 124 for rotating generator 124 in response to linear oscillation of the ballast 122 in response to pitching of watercraft 100, resulting from watercraft 100 being exposed to swells (or waves).

For another embodiment, movable ballast 122 is located in keel 112. For other embodiments, movable ballast 122 is located in keel bulb 114, as shown in FIG. 1. For some embodiments, movable ballast 122 may be located in the interior of hull 108. For one embodiment, electrical generator 124 and storage device 120 are located within the interior of hull 108. For another embodiment, storage device 120 is electrically connected to one or more electrical devices 121, such as navigation equipment, autopilots, DVD players, lights, etc.

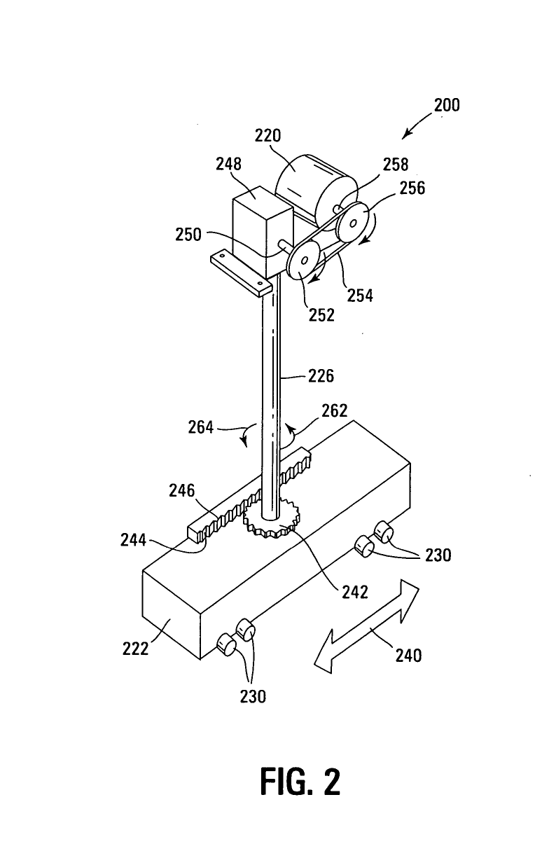

FIG. 2 illustrates an electrical power generation system 200 that can be disposed in a watercraft, such as watercraft 100, for generating electricity, according to another embodiment. Electrical power generation system 200 includes movable ballast 222. Rollers 230 are rotatably attached to ballast 222, e.g., using bearings, such as journal, roller, or ball bearings. Ballast 222 oscillates linearly, as indicated by arrow 240, in response to pitching of the watercraft, resulting from the watercraft being exposed to swells (or waves). A rack 246 having teeth 244 is secured to ballast 222. A pinion 242 disposed on a shaft 226, e.g., using a press fit, a set screw threaded through pinion 242 so as to engage a key disposed in a keyway formed in shaft 226, or the like meshes with teeth 244. Pinion is spaced slightly above ballast 222, so it is free to rotate in response to the movement of ballast 222 and thereby rack 246.

Shaft 226, for one embodiment, rotatably connects to a gear box 248 containing gears for stepping up the rotational speed delivered by the shaft. An output shaft 250 of gear box 248 connects to a first (or driver) pulley (or sprocket) 252, and a second (or driven) pulley (or sprocket) 256 connects to an input shaft 258 of an electrical generator 220. A belt 254 connects first pulley 252 to second pulley 256, or a chain connects the first and second sprockets for another embodiment. For one embodiment, gear box 248 containing gears for stepping up the rotational speed delivered by the shaft, first pulley 252, second pulley 256, and belt 254 constitute a drive train of electrical power generation system 200.

In operation, for one embodiment, as ballast 222 oscillates in the directions of arrow 240, rack 246 oscillates while meshing with pinion 242. This causes shaft 226 to oscillate, as indicated for one direction of oscillation by arrow 262 and arrow 264. In turn, the oscillatory motion is delivered to gear box 248, which outputs the oscillatory motion to pulley 252. Pulley 252 delivers the oscillatory motion to pulley 256, which delivers oscillatory motion to input shaft 258 and thus to generator 220. Generator 220 generates electricity in response to the oscillatory motion and delivers the electricity to a storage device, such as storage device 120 of FIG. 1.

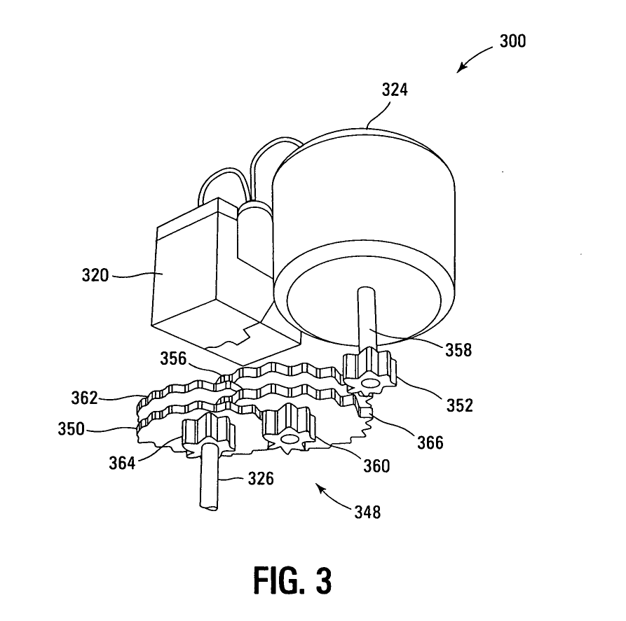

FIG. 3 illustrates a portion 300 of an electrical power generation system for watercraft, according to another embodiment. A drive shaft 326 is connected to a movable ballast, such as movable ballast 222 of FIG. 2. For one embodiment, a pinion, such as pinion 242 of FIG. 2, meshes with a rack, such as rack 246 of FIG. 2, that is secured to the ballast. For another embodiment, shaft 326 is connected to a drive train, such as a gear train 348. For one embodiment, gear train 348 may be disposed in a gear box, such as gear box 248 of FIG. 2.

For some embodiments, gear train 348 mechanically couples shaft 326 to an electrical generator 324 that may be electrically connected to a storage device 320, such as a battery. For one embodiment, shaft 326 is coupled to a first gear 350 of gear train 348, and a last gear 356 of gear train 348 meshes with a pinion 352 disposed on an input shaft 358 of generator 324. Note that first gear 350 meshes with a second gear 360 that is connected to the last gear 356. Note further that first gear 350 has a larger circumference (or more teeth) than second gear 360, so that second gear 360 has a higher rotational speed than first gear 350, which has the same rotational speed as shaft 326. Moreover, last gear 356 has a larger circumference (or more teeth) than pinion 352, so that pinion 352 has a larger rotational speed than last gear 356, which has the same rotational speed as second gear 360. Therefore, pinion 352 has a larger rotational speed than shaft 326. This illustrates the step-up function in rotational speed of gear train 348.

For other embodiments, a third gear 362 may be connected to first gear 350, and for one embodiment, a fourth gear (not shown) may be sandwiched between first gear 350 and third gear 362. For some embodiments, third gear 362 and first gear 350 may have the same number of teeth, while the fourth gear may have the same number of teeth as a fifth gear 364, connected to first gear 350. The fourth gear may mesh with a sixth gear (not shown) sandwiched between last gear 356 and a seventh gear 366 that is connected to second gear 360. For some embodiments, seventh gear 366 and last gear 356 have the same number of teeth, and for other embodiments, the sixth gear has the same number of teeth as second gear 360.

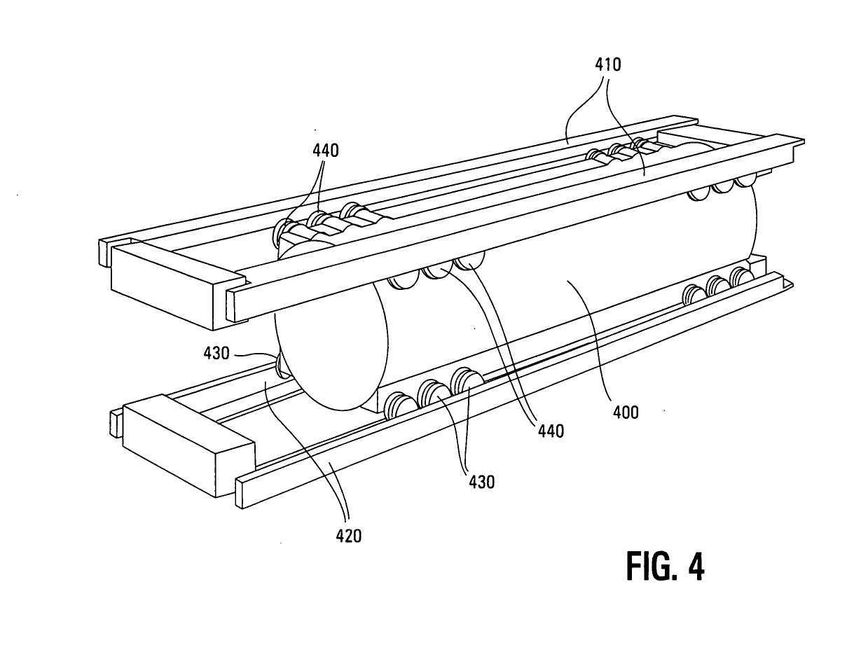

FIG. 4 illustrates movable ballast disposed between a first pair of interconnected rails 410 and a second pair of interconnected rails 420, according to an embodiment. The first pair of interconnected rails 410 and/or the second pair of interconnected rails 420 are secured to either keel 112 or keel bulb 114 of FIG. 1. Rollers 440 and rollers 430 are respectively in rollable contact with the first pair of interconnected rails 410 and the second pair of interconnected rails 420. Moreover, rollers 440 and rollers 430 are rotatably connected to ballast 400.

### Conclusion

Although specific embodiments have been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. Accordingly, this application is intended to cover any adaptations or variations of the invention. It is manifestly intended that this invention be limited only by the following claims and equivalents thereof.

What is claimed is:

1. An electrical power generation system for watercraft, comprising:
movable ballast;
an electrical generator; and
a shaft connected between the ballast and the electrical generator.

2. The electrical power generation system of claim 1, wherein during operation the shaft rotates the generator in response to linear oscillation of the ballast in response to pitching of the watercraft.

3. The electrical power generation system of claim 1, and further comprising a drive train that mechanically couples the shaft to the electrical generator.

4. The electrical power generation system of claim 3, wherein the drive train is adapted to step up a rotational speed delivered thereto by the shaft.

5. The electrical power generation system of claim 1, wherein the movable ballast is disposable in a keel of the watercraft.

6. The electrical power generation system of claim 5, wherein the keel protrudes from an exterior of a hull of the watercraft.

7. The electrical power generation system of claim 1, wherein the generator is located in an interior of a hull of the watercraft.

8. The electrical power generation system of claim 1, wherein the movable ballast is disposable in a keel bulb of the watercraft.

9. The electrical power generation system of claim 1, wherein the generator is electrically connectable to a battery.

10. The electrical power generation system of claim 1, and further comprising:
a rack attached to the movable ballast; and
a pinion disposed on the shaft that meshes with the rack.

11. The electrical power generation system of claim 1, and further comprising a plurality of rollers rotatably attached to the movable ballast.

12. An electrical power generation system for watercraft, comprising:
movable ballast;
an electrical generator;
a shaft connected to the ballast and mechanically coupled to the electrical generator for rotating the generator in response to linear oscillation of the ballast in response to pitching of the watercraft; and
a battery electrically connected to the electrical generator.

13. The electrical power generation system of claim 12, and further comprising a drive train that mechanically couples the shaft to the electrical generator.

14. The electrical power generation system of claim 13, wherein the drive train is adapted to step up a rotational speed delivered thereto by the shaft.

15. The watercraft of claim 13, wherein the drive train comprises:
a first pulley or sprocket rotatably connected to a gear box and a second pulley or sprocket rotatably connected to the generator and
a belt connecting the first and second pulleys or a chain connecting the first and second sprockets.

16. The electrical power generation system of claim 12, and further comprising:
a rack attached to the movable ballast; and
a pinion disposed on the shaft that meshes with the rack.

17. A watercraft comprising:
movable ballast;
an electrical generator;
a shaft connected to the ballast and mechanically coupled to the electrical generator for rotating the generator in response to linear oscillation of the ballast in response to pitching of the watercraft; and
a battery electrically connected to the electrical generator.

18. The watercraft of claim 17, and further comprising a drive train that mechanically couples the shaft to the electrical generator.

19. The watercraft of claim 17, wherein the movable ballast is located in a keel of the watercraft.

20. The watercraft of claim 17, wherein the generator is located in an interior of a hull of the watercraft.

21. The watercraft of claim 17, wherein the movable ballast is located in a keel bulb of the watercraft.

22. The watercraft of claim 17, wherein the ballast is in rollable contact with rails attached to the watercraft.

23. The watercraft of claim 17, wherein the battery is further electrically connected to electrical devices of the watercraft.

24. A watercraft comprising:
a hull;
a keel protruding from an exterior surface of the hull;
movable ballast disposed in the keel or a keel bulb connected to the keel;
an electrical generator disposed in an interior of the hull;
a shaft connected to the ballast;
a drive train mechanically coupled between the electrical generator and the shaft; and
a battery having inputs electrically connected to outputs of the electrical generator.

25. The watercraft of claim 24, wherein the drive train comprises a gear train.

26. The watercraft of claim 24, wherein the drive train is adapted to step up a rotational speed delivered thereto by the shaft.

27. The watercraft of claim 24, wherein the drive train comprises:
a first pulley or sprocket rotatably connected to a gear box and a second pulley or sprocket rotatably connected to the generator and
a belt connecting the first and second pulleys or a chain connecting the first and second sprockets.

28. The watercraft of claim 24, wherein outputs of the battery are electrically connected to electrical devices of the watercraft.

29. The watercraft of claim 24, wherein the watercraft is a sailboat.

30. A method for generating electricity for a watercraft, comprising:
linearly oscillating ballast of the watercraft in response to pitching of the watercraft;
converting the linear oscillations of the ballast into rotational motion; and
generating electricity from the rotational motion.

31. The method of claim 30, wherein converting the linear oscillations of the ballast into rotational motion comprises:
meshing a rack attached to the ballast with a pinion disposed on a drive shaft; and
coupling the shaft to a generator.

32. The method of claim 31, wherein coupling the drive shaft to the generator comprises connecting the drive shaft to a drive train and connecting the drive train to the generator.

33. The method of claim 31, wherein coupling the drive shaft to the generator comprises:
connecting the drive shaft to a first gear of a drive train; and
meshing a last gear of the drive train to a pinion disposed on an input shaft of the generator.

34. The method of claim 31, wherein coupling the drive shaft to the generator comprises:
rotatably connecting the drive shaft to a gear box; and
connecting a first pulley that is connected to an output shaft of the gear box to a second pulley that is connected to an input shaft of the generator using a belt, or connecting a first sprocket that is connected to the output shaft of the gear box to a second sprocket that is connected to the input shaft of the generator using a chain.

35. The method of claim 30, and further comprising storing the generated electricity.
